(19) United States
(12) Patent Application Publication
(10) Pub. No.: US 2021/0227782 A1
(43) Pub. Date: Jul. 29, 2021

(54) SWINE FEEDING SYSTEM AND METHOD OF CLEANING SAME

(71) Applicant: Kyle Donald Morrison, South English, IA (US)

(72) Inventor: Kyle Donald Morrison, South English, IA (US)

(21) Appl. No.: 17/156,906

(22) Filed: Jan. 25, 2021

Related U.S. Application Data
(60) Provisional application No. 62/964,843, filed on Jan. 23, 2020.

(51) Int. Cl. A01K 1/02; F16L 41/02; A01K 5/02

(52) U.S. Cl. CPC A01K 1/0209; A01K 5/0225; F16L 41/021

(57) ABSTRACT

A system and method for feeding hogs in a hog confinement and cleaning said system, which includes overhead feed distribution pipe, with a boot situated to receive feed from the overhead feed distribution pipe, and a downspout which directs feed to a feeder. A two-piece connector between the boot and the downspout is provided to allow for quick and easy detachment of the downspout from the boot.

One embodiment of the two-piece connector is a hinged connector which, when open, goes around an exterior of an exit port of the boot and around an input end of the downspout. When hinged connector is closed, it retains the downspout to the boot. A latch may be used to keep the hinged connector closed.

In another embodiment, a top connector is coupled to the exit port of boot, in a well known manner such as screws, and a bottom connector is connected to an input end of the downspout in a similar manner. Each of the top and bottom connectors has a flange and either a multiple width slot or a stud with larger head portion thereon for allowing a quick rotation to allow for alignment of the stud with a narrow slot portion to allow for retention.

### CROSS REFERENCE TO RELATED APPLICATIONS

This application is a non-provisional patent application, which claims the benefit of the filing date of a provisional application having Ser. No. 62/964,843 filed by the same inventor on Jan. 23, 2020, the contents of which are incorporated herein in their entirety by this reference.

### FIELD OF THE INVENTION

The present invention relates to animal feed systems and more specifically feed systems for hog confinements.

### BACKGROUND OF THE INVENTION

It is common for feed systems in hog confinements to have a network of overhead supply lines (often PVC pipe, translucent pipes or suitable substitutes) which convey animal feed to various locations inside the hog confinement. These overhead supply lines are often coupled to a boot, T, or funnel-like structure which accepts feed from the overhead supply lines and directs it to a downspout coupled to the boot. The downspout is coupled to a feeder on the ground where the animals are able to access the feed while keeping the feed off the floor of the hog confinement. It is common that these hog confinements, including the feeders, floors, gates, downspouts etc., need to be cleaned.

In the past, the boots have been held adjacent to the overhead supply lines by a snap in connection, clamps, or suitable substitutes. Generally, it is necessary to remove the downspout from the bottom (exit) port of the boot in order to remove the downspout from the feeder.

It is common to attach the downspout to the boot running several screws from the outside of the downspout through downspout and into an exit port on the boot. These screws are time consuming to remove and replace, often making detachment of the downspout too laborious.

One method of avoiding these screws has been to use a downspout bisecting pin which extends through a first side of the downspout, through the first side of the exit port of the boot, then across the entire opening in the downspout through which feed is allowed to flow, and then through a second side of the boot and a second side of the downspout where it is retained by some type of cotter pin, latch, key, etc.

To feed the downspout bisecting pin through four predrilled holes in the downspout and boot exit port often requires time and patience, which is limited during a hog confinement clean event.

Another problem with the downspout bisecting pin is that there is contact between this bisecting pen and the feed passing past it. This can wear away the pin, and result in pieces of the pin passing into the feed and potentially risking the health of the hogs. This system also wiggles and causes friction between the downspout, the boot, and the pin resulting in degradation of these components. Also this movement results in generation of noise, which can be substantial when there may be many downspouts within one hog confinement.

Consequently, there exists a need for improved methods and systems for providing feed to hogs in a hog confinement, and cleaning such systems, all done in a reliable and cost efficient manner.

### SUMMARY OF THE INVENTION

It is an object of the present invention to provide a system for delivering feed to swine in a confinement and method for cleaning the same in an efficient manner.

It is a feature of the present invention to utilize a two-piece intermediate connector between an exit port of a boot and an input end of a downspout.

It is an advantage of the present invention to reduce the time to remove and replace a downspout.

It is another feature of the present invention to include the ability for relative movement within said two-piece intermediate connector

It is another advantage of the present invention to reduce the need for skilled labor to remove and replace a downspout.

The present invention provides for a wiggle-free connection between the downspout and the boot which allows for quick detachment/replacement of the downspout from/to the boot. The system allows for quick and easy storage of the downspout while it is detached from the boot. The system of the present invention involves:

coupling of the downspout to the boot without doing either of the following: putting a screw through both one portion of the downspout and a portion of the boot; or causing a pin to span the opening inside the downspout and the boot where feed must flow;

a two-piece connector system which forms a readily detachable and re-attachable connection between the boot and the downspout;

where a first piece of said two-piece connector is configured to mate with a first one of said boot and said downspout;

where a second piece of said two-piece connector system is configured to mate with another one of said boot and said downspout.

In one embodiment, the each piece of said two-piece connector system is configured to mate with both of said boot and said downspout.

Accordingly, the present invention is a system for providing feed to hogs in a hog confinement, the system comprising:

a first overhead supply line, configured to transport feed from a first location to a second location;

a boot, configured to receive therein feed which has been transported through said first overhead supply line, said boot having an exit port, with an exit port outside diameter;
a downspout, with an input end, with an input end inside diameter which is larger than said exit port outside diameter; and a connector having a first piece and a second piece, where said first piece is configured to be coupled to said exit port, without having any single member extending through said input end and into said exit port; and where said second piece is configured to be coupled to said input end, without having any single member extending through said input end and into said exit port.

### BRIEF DESCRIPTION OF THE DRAWINGS

The invention may be more fully understood by reading the following description of the preferred embodiments of the invention, in conjunction with the appended drawings wherein:

FIG. 1 is a simplified view of a system of the present invention showing two alternate connectors.

FIG. 2 is a perspective view of a first alternate embodiment 40 of the two-piece connector systems shown in FIG. 1.

FIG. 3 is a top view of the system 40 of FIG. 2.

FIG. 4 is a hinged side view of the system 40 of FIG. 2.

FIG. 5 is an intermediate view of the system 40 of FIG. 2.

FIG. 6 is a clasp side view of the system 40 of FIG. 2.

FIG. 7 is a perspective view of one piece of the two-piece system 40 of FIG. 2 without any hinge or clasp.

FIG. 8 is a side view of the piece of the two-piece system 40 of FIG. 7 without any hinge or clasp.

FIG. 9 is a top view of the piece of the two-piece system 40 of FIG. 7 without any hinge or clasp.

FIG. 10 is a perspective view of a second alternate embodiment 50 of the two-piece connector systems shown in FIG. 1, in an assembled and pinned configuration.

FIG. 11 is a side view of the system 50 of FIG. 10.

FIG. 12 is a top view of the system 50 of FIG. 10.

FIG. 13 is a bottom view of the system 50 of FIG. 10.

### DETAILED DESCRIPTION

Through this description details are given of hog feeding system for use in a building. It is intended that these specific details not limit the scope of the present invention, unless repeated in the claims, but instead fully enable a specific and/or best mode of the invention and other variations of this hog confinement feeding system are intended to be readily understood from the following description and included within the scope and spirit of the present invention.

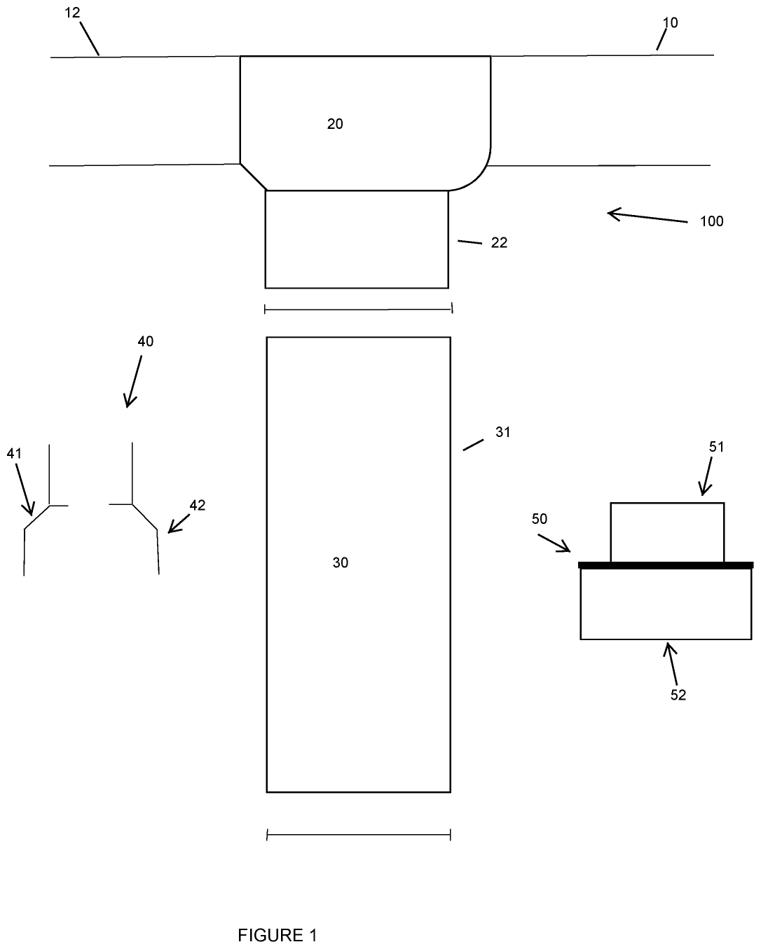

Now referring to the drawings wherein like numerals refer to like matter throughout, and more specifically referring to FIG. 1, there is shown the system of the present invention, generally designated 100, which includes a first overhead supply line 10 which may include an auger to move feed throughout a network of feed lines. Pipe 12 may be a separate pipe of a different part of a much longer pipe which extends through boot 20 and has a hole therein so that feed in the pipes 10 and 12 can fall into the boot 20 and exit out of the boot exit port 22. There is also shown a downspout 30 which is configured with an input end 31 with an inside diameter which is larger than the outside diameter of the exit port 22. The opposing end of downspout 30 is configured to discharge feed into a feeder (not shown). The components discussed in this paragraph are all well known in the art.

However, this FIG. 1 includes two alternate embodiments of a two-piece connector which are configured to couple the downspout 30 to the boot 20. The two-piece connectors of the present invention can be made of plastic, metal or any suitable material.

Shown in FIG. 1 is a first embodiment 40 with two opposing lateral sides 41 and 42.

Also shown in FIG. 1 is a second embodiment 50, which could be used instead of system 40, where system 50 has two portions which are arranged in a substantially stacked configuration.

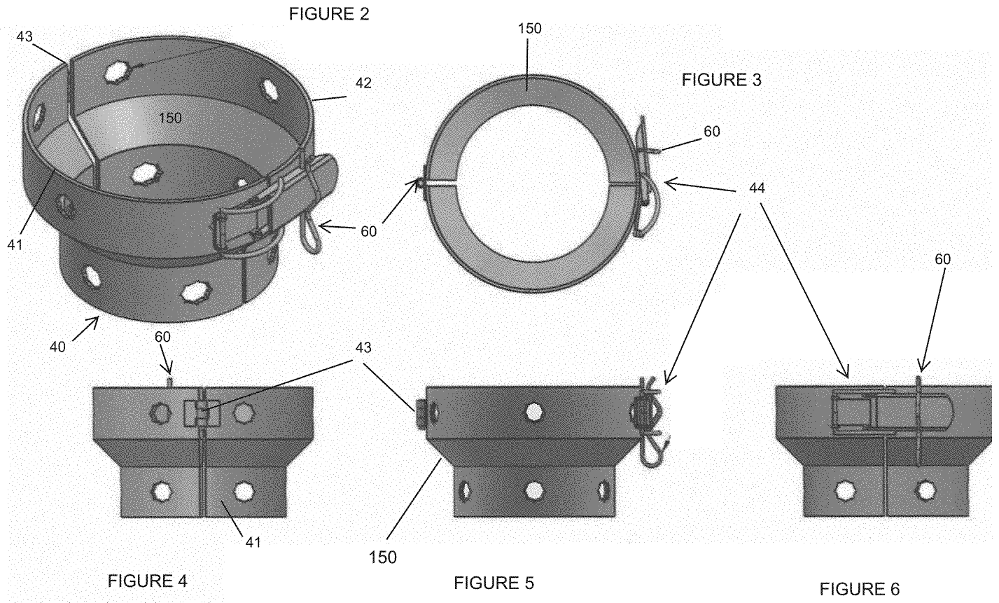

Now referring to FIGS. 2-9, there are shown various views of the first system 40 of FIG. 1, and more specifically, FIG. 2 shows a perspective view of a system 40, with first part 41, second part 42, hinge 43, and clasp 44. The top opening is cylindrical and is shown larger than the narrower cylindrical bottom portion in FIGS. 2-9, but it would need to be inverted when utilized between the boot 20 and downspout 30 as shown in FIG. 1. An angled non-cylindrical transition region 150 is shown to join a wider cylindrical portion and the narrower cylindrical bottom portion.

Now referring to FIG. 3, there is shown a top view of the system of FIG. 2.

FIG. 4 shows a hinged side view, while FIG. 5 shows an intermediate view and FIG. 6 shows a clasp side view.

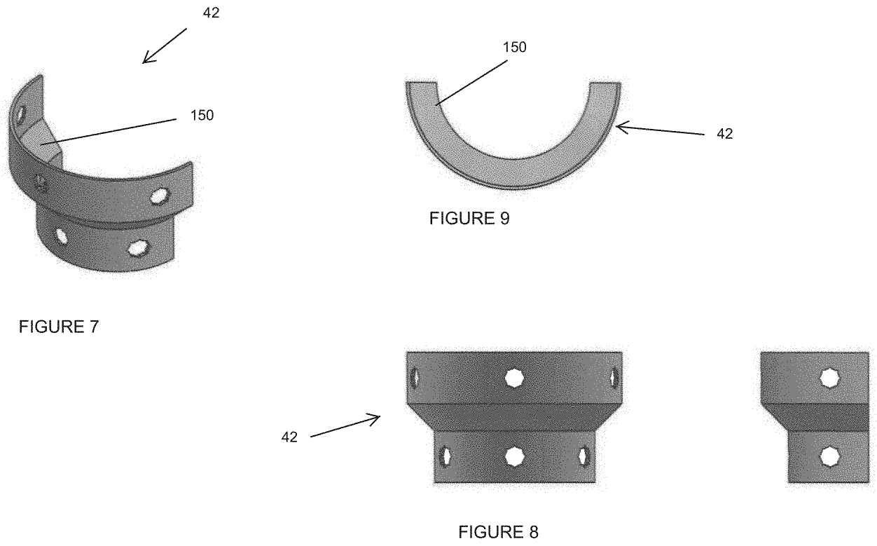

FIGS. 7, 8 and 9 all show differing views of the same part 42, which may be substantially identical to part 41.

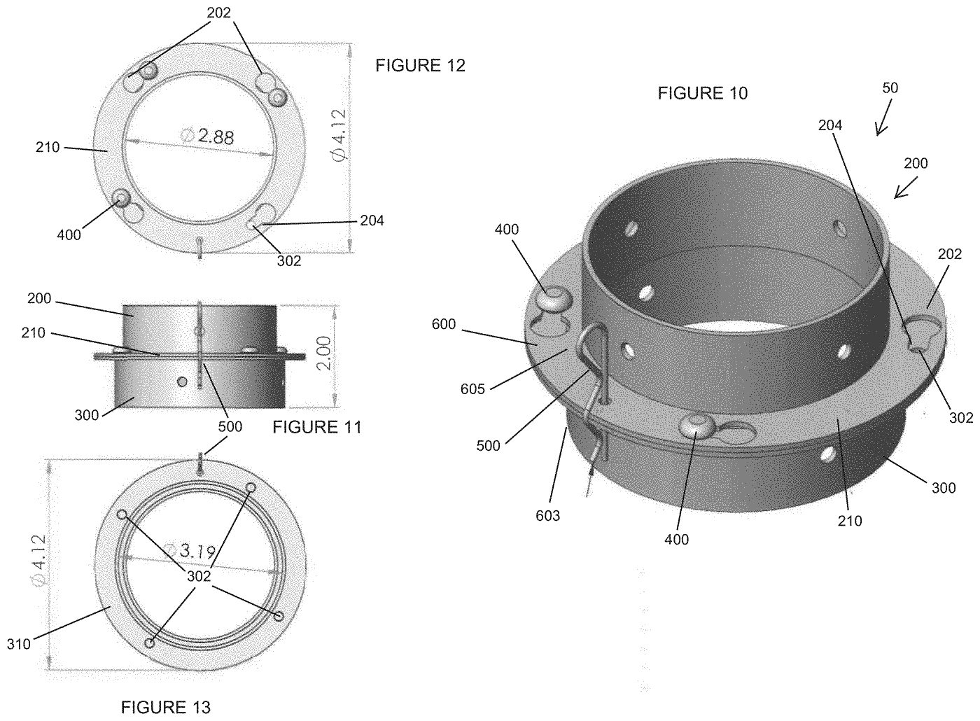

Now referring to FIG. 10, there is shown a perspective view of a second alternate embodiment 50 of the two-piece connector systems shown in FIG. 1, in an assembled and pinned configuration. This embodiment is shown in FIG. 1 as having two parts 51 and 52, in FIGS. 10-13, 200 and 300 are intended to refer to the same structures shown as 51 and 52, respectively in FIG. 1. The orientation of the system 50 in FIGS. 10-13 is correct and would “top” end mate with the boot exit port 22 of FIG. 1. Portion 200 is essentially a small cylinder with a wide bottom flange and portion 300 is a large cylinder with a narrower flange. Wide flange 210 has several orifices therethrough each with a wide head receiving portion 202 and a narrower shaft receiving portion 204, which are configured to receive the head and shaft portions of fastener 400 coupled to the narrower flange of portion 300. Portion 200 and 300 are shown with several holes to receive self-taping screws which could engage boot exit port 22 and the downspout 30, respectively. A cotter pin 500 is shown in two aligned holes through the flanges. Attached to cotter pin 500 is elongated chain/cable 600, which is securely coupled to the cotter pin and the lower portion using suitable means, such as welding, clamps, etc. The length of the chain 600 is important because it provides a key benefit of the present invention in allowing the chain 600 to be looped over pipe 10 or 12 and pinned back into the hole in the flange of portion 300 after the downspout has been detached from the boot exit port 22 and top portion 200.

FIG. 12 is a top view showing an empty hole 302 in the flange of portion 300, in alignment with the shaft receiving portion 204. In FIGS. 10 and 12, one of the fasteners 400 is shown as omitted for illustration purposes, but in an actual system, all holes will be filled with fasteners 400, which could be welded in place or attached using other well-known means.

FIG. 13 is a bottom view of the system 50 showing the holes 302 all filled with welded-in fastener shaft portions.

The present invention also includes an innovative method of cleaning a hog confinement comprising the steps of:

detaching a down spout at its top end 31 from a connection with a boot exit port 22 without removing any downspout dissecting pin, and without removing a single screw, which single screw extended at least partially through said boot exit port 22 and downspout top end 31;

removing a pin which is not disposed in the portion of the downspout through which feed flows, where pin removal is a prerequisite to step 3;

causing relative motion, in a first direction, between the two pieces of a two-piece connector, which relative motion results in permitting the downspout to be pulled downward from said boot exit port;

removing the outlet end of the downspout from a feeder;

looping the pin, with elongated chain coupled between the pin and the downspout, over an overhead supply line and coupling the pin so as to cause the downspout to be supported above the floor of the hog confinement by the overhead supply line;

cleaning the feed and/or floor of the hog confinement;

replacing the downspout by removing the pin and lowering the downspout;

pushing the downspout upwards toward the boot exit port;

causing relative motion between said two pieces of a two-piece connector, thereby holding the downspout in place; and

inserting a pin in a position which does not span any portion of the downspout through which feed flows.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

1. A system for providing feed to hogs in a hog confinement, the system comprising:
a first overhead supply line, configured to transport feed from a first location to a second location;
a boot, configured to receive therein feed which has been transported through said first overhead supply line, said boot having an exit port, with an exit port outside diameter;
a downspout, with an input end, with an input end inside diameter which is larger than said exit port outside diameter; and
a connector having a first piece and a second piece, where said first piece is configured to be coupled to said exit port, without having any single member extending through said input end and into said exit port; and where said second piece is configured to be coupled to said input end, without having any member extending through said input end and into said exit port.

2. The system of claim 1 wherein said first piece is configured to engage both said input end and said exit port.

3. The system of claim 1 wherein said first piece is configured to engage only one of said input end and said exit port.

4. The system of claim 2 wherein said first piece is configured to mate with the second piece through a hinge.

5. The system of claim 4 wherein said first piece and said second piece are further configured to selectively mate with each other through a clasp.

6. The system of claim 5 wherein said first piece and said second piece are configured with teeth extending inward to grip one of said exit port and said input end.

7. The system of claim 6 wherein said first piece and said second piece are configured with a protuberance extending to grip both of said exit port and said input end.

8. The system of claim 7 wherein said first piece has an angled non-cylindrical transition region therein.

9. The system of claim 3 wherein said first piece is configured to engage said exit port and has a wide flange with a plurality of orifices therethrough each with a wide head receiving portion and a narrower shaft receiving portion.

10. A system for reducing cleaning time required for an overhead feed system in a hog confinement building, the system comprising:
a plurality of intermediate connector pieces;
a means for constraining relative movement between said plurality of intermediate connector pieces; and
a means for stopping relative movement which would have been permitted by said means for constraining relative movement between said plurality of intermediate connector pieces.

11. The system of claim 10 further comprising a feed supply vessel disposed above a floor configured to support swine, said feed supply vessel being coupled to and configured for providing flow of feed to said plurality of intermediate connector pieces.

12. The system of claim 11 further comprising a boot disposed between said feed supply vessel and said plurality of intermediate connector pieces.

13. The system of claim 12 further comprising a downspout coupled to said boot by said plurality of intermediate connector pieces.

14. The system of claim 13 wherein said means for constraining relative movement includes a hinge.

15. The system of claim 13 wherein said means for constraining relative movement included a slotted flange.

16. The system of claim 14 wherein said means for stopping relative movement includes a latch.

17. The system of claim 15 wherein said means for stopping relative movement includes a pin through said slotted flange.

18. A method of improving efficiency of removing a downspout from an overhead feed vessel in a hog confinement building, the method comprising the steps of:
providing a feed distribution system with a plurality of feed supply vessels disposed above a floor configured to support swing;
providing a boot below one of said plurality of feed supply vessels, said boot being configured to receive swine feed from said one of said plurality of feed supply vessels;
providing a downspout;
providing a plurality of intermediate connector pieces, which are disposed between said boot and said downspout, and which are configured, in combination, to:
provide for containing moving animal feed therethrough;
detaching said downspout from fluid communication with said boot; and
where said step of detaching is done without removing any member which extends into any feed flow portion of a vessel which is configured to move feed from said boot to a lower location.

19. The method of claim 18 where said step of detaching is done without the use of a hand held tool to interact with screws, bolts, or nuts.

20. The method of claim 18 where said step of detaching is done without a need to pull downward on the downspout.
